(19) United States
(12) Patent Application Publication
(10) Pub. No.: US 2023/0394742 A1
(43) Pub. Date: Dec. 7, 2023

(54) METHOD FOR PARAMETERIZING AN IMAGE SYNTHESIS FROM A 3-D MODEL

(71) Applicant: dSPACE GmbH, Paderborn (DE)

(72) Inventors: Andre SKUSA, Paderborn (DE); Nikolas HEMION, Paderborn (DE); Sven BURDORF, Paderborn (DE); Daniel HASENKLEVER, Paderborn (DE)

(73) Assignee: dSPACE GmbH, Paderborn (DE)

(21) Appl. No.: 18/236,037

(22) Filed: Aug. 21, 2023

Related U.S. Application Data
(63) Continuation of application No. PCT/EP2021/084149, filed on Dec. 3, 2021.

(30) Foreign Application Priority Data
Feb. 22, 2021 (DE) 10 2021 104 110.4

(51) Int. Cl. G06T 15/20; G06T 17/00; G06T 7/00; G06V 10/82; G06V 10/764; G06V 10/774; G06T 9/00

(52) U.S. Cl. CPC G06T 15/20; G06T 17/00; G06T 7/0002; G06V 10/82; G06V 10/764; G06V 10/774; G06T 9/002; G06T 2207/20084; G06T 2207/20081; G06T 2200/08

(57) ABSTRACT

A method for parameterizing a program logic for image synthesis to adapt images synthesized by the program logic to a camera model. A digital photograph of a three-dimensional scene is processed by a neural network and an abstract first representation of the photograph is extracted from a selection of layers of the neural network. The program logic is parameterized according to an initial set of output parameters in order to synthesize an image that recreates the photograph from a three-dimensional model of the scene. The synthetic image is processed by the same neural network, an abstract second representation of the synthetic image is extracted from the same selection of layers, and a distance between the synthetic image and the photograph is calculated based on a metric that takes into account the first representation and the second representation.

This nonprovisional application is a continuation of International Application No. PCT/EP2021/084149, which was filed on Dec. 3, 2021, and which claims priority to German Patent Application No. 10 2021 104 110.4, which was filed in Germany on Feb. 22, 2021, and which are both herein incorporated by reference.

### BACKGROUND OF THE INVENTION

### Field of the Invention

The present invention relates to a method for parameterizing an image synthesis from a 3D model.

### Description of the Background Art

Especially in the automotive industry, it has been common practice for many years to test control systems for vehicles in virtual environments. Depending on the design of the DUT, the methods for this are known as Hardware in the Loop (HiL), Software in the Loop (SiL), Processor in the Loop (PiL), Model in the Loop (MiL) or Vehicle in the Loop (ViL). What they all have in common is that the control system under test is in a control loop with a simulation computer. The simulation computer simulates an application environment of the control system, for example a street scene, generates synthetic input data for the control system on the basis of the simulation and feeds it into the control system. In other words, the control system is simulated to be used in a physical environment in which it is can be tested safely and under reproducible conditions. The control loop can be designed as a closed control loop. In this case, data generated by the control system is fed back into the simulation to control a simulated machine there, such as a vehicle.

More recently, many manufacturers are working on autonomous systems that can move in the environment without human control. Level 3 automated cars, in which the driver can let go of the steering wheel for a longer period of time even during regular driving, are already available to end customers. Similar developments are taking place in aviation and robotics. Such systems are often equipped with cameras which are followed by object recognition based on a neural network.

Simulation systems of the type described above must always be designed to credibly simulate to the DUT their use in a physical environment. To test a camera-based control system with object recognition, the simulation computer must therefore include a photorealistic graphical real-time simulation of a virtual environment, on the basis of which the simulation computer generates emulated raw data from a camera sensor and feeds it into the control system. The gaming industry in particular has suitable rendering software for this purpose. Graphics engines such as Unreal Engine, CryEngine or Unity Game Engine are increasingly also being used in the development of camera-based control systems.

Since it is possible to confront a control system with specific situations in a virtual environment, one test kilometer in a virtual test environment can replace many test kilometers in the real environment. Unfortunately, the usability of virtual test environments for camera-based control systems is still limited according to the state of the art because the images rendered by graphics engines in real time are still easily distinguishable from actual camera images. Accordingly, the performance of a control system in a virtual environment can only be used to a limited extent to draw conclusions about its performance in the field. Another field of application is the use of a graphics engine to generate synthetic training data in order to train a neural network of the control system, for example, to recognize pedestrians, traffic signs, vehicles and more. It is not yet possible to fully rely on synthetic training data for this purpose. The danger is too great that the neural network will get used to the synthetic data and, despite sufficient performance in the virtual environment, will fail in the field in a critical situation.

Graphics engines common on the market include a variety of adjustable parameters, the values of which affect the appearance of a synthesized image. These parameters can be used to best match the synthesized image to the image produced by a real camera. However, the parameter space is normally so high-dimensional that no optimal parameterization can be determined in a reasonable time by simply trying out different parameter sets manually.

### SUMMARY OF THE INVENTION

It is therefore an object of the present invention to facilitate the adaptation of synthesized images to a given camera by parameterizing a program logic for image synthesis.

The invention is an automatable iterative method for parameterizing a program logic for image synthesis, which is designed to synthesize a photorealistic perspective representation of a 3D model, the appearance of which depends on a variety of adjustable parameters.

This requires a suitable metric that provides a numerical measure of the similarity between two images. Classical methods for checking the similarity between two images, which are based on a pixel-by-pixel comparison of the images, e.g., the mean square deviation of the color values, are not very suitable for this purpose. For example, it would not be possible to reliably check the correct position of a light source using such a method, because a different gradient of shadows may have little effect on the mean value of the pixel colors. Furthermore, it is not possible with reasonable effort to replicate a photograph in detail using a graphics engine. For example, a truck depicted in the photograph is usually replaced in the synthetic image by a generic model of a truck whose geometric shape is different, on which the same company logo is not printed, etc. A pixel-by-pixel comparison of the images would detect large differences between the two, which are irrelevant to the object to be achieved. What is needed is a metric that measures image similarity on a global scale, which is a good measure of what people typically subjectively perceive as similar.

It is known from the paper “The Unreasonable Effectiveness of Deep Features as a Perceptual Metric” (Richard Zhang et al., Proceedings of the IEEE Conference on Computer Vision and Pattern Recognition, arXiv:1801.03924, 2018), which is herein incorporated by reference, that intermediate representations of images from hidden layers of pretrained neural networks are a good measure of image similarity according to human perception. To this end, the authors compare photographs with deliberate falsifications of the same. For the invention, it is provided to compare a photograph with rendered replicas of the photograph in a similar fashion.

The plan is to provide a digital photograph of a three-dimensional scene, to process the photograph by a neural network and to extract a first representation of the photograph from a selection of neurons of the neural network. The selection of neurons advantageously includes neurons from a hidden layer of the neural network arranged between the input layer and the output layer, especially advantageously from a plurality of hidden layers.

The selection of neurons is advantageously designed as a selection of layers of the neural network and includes all neurons belonging to the respective layer from each layer from the selection of layers. In other words, the selection of neurons in this embodiment is formed exclusively of complete layers of the neural network, of which advantageously at least one layer is a hidden layer. The first representation thus includes at least one complete intermediate representation of a digital photograph stored in a hidden layer of the neural network.

A digital photograph is an image of a scene in a physical environment taken by means of a digital camera and stored in digital form. It is irrelevant for the method as to whether the photograph is taken as a single image or extracted from a film recording.

Furthermore, a digital three-dimensional model of the scene is planned to be provided. In particular, this can be understood as a semantic description of a replica of the scene that can be read and processed by the program logic for image synthesis, on the basis of which an image recreating the scene can be synthesized by means of the program logic. The semantic description preferably includes a list of graphic objects and an assignment of parameters to each graphic object, in particular a position and a spatial orientation, and the program logic is designed to generate a suitable texture for each object.

In preparation for the first iteration step, an initial set of output parameters is created, comprising a selection of parameters of the program logic to be set with more or less arbitrary values, and the program logic is parameterized according to the output parameter set, i.e., the parameters listed in the initial output parameter set are set to the values assigned to them in the initial output parameter set. The parameterization is preferably done either by means of a programming interface of the program logic, or the program routines for executing the method are integrated into the program logic. By means of the parameterized program logic, a synthetic image is synthesized on the basis of the three-dimensional model, which recreates the photograph. To do this, a virtual camera of the program logic must be set up in such a way that the synthesized image shows the recreated scene from the same perspective as the photograph shows the physical scene. The synthesized image is thus a kind of synthetic twin of the photograph, the image of which is essentially, although generally not in detail, consistent with the photograph.

The synthetic image is processed by the same neural network that was used to process the photograph (i.e., either with the same instance of the neural network or by an identical copy of it), and a second representation of the synthetic image is extracted from the same selection of neurons from which the representation of the photograph is extracted.

Subsequently, the distance between the synthetic image and the photograph is calculated, wherein the calculation is made using a metric that takes into account the first representation and the second representation.

The first and second representations can be, for example, sets of activation function values read from neurons. This distance calculation is based on the assumption that the more similar the photograph and the synthetic image are to each other, the more similar the two extracted representations are to each other, and that furthermore, since image-processing neural networks are natively designed to recognize global relationships in images, slight differences between photography and synthetic image, such as a slightly different geometry of an object and its virtual counterpart, have a relatively minor impact.

An iterative algorithm improves the initial set of output parameters in such a way that the images synthesized on its basis become more similar to the photograph. The iterative algorithm includes the following method steps: (a) Creation of a number of parameter sets by varying the output parameter set; Repetition of the method steps previously performed for the initial output parameter set for each parameter set from the number of parameter sets in order to calculate a distance from the photograph for each parameter set. In other words, for each parameter set from the multitude of parameter sets: parameterization of the program logic according to the respective parameter set; resynthesis of the synthetic image by means of the program logic parameterized according to the parameter set; (b) processing of the new synthetic image by the neural network; Re-extraction of the second representation of the new synthetic image from the same selection of neurons from which the first representation is extracted; and calculation of the distance between the new synthetic image and the photograph based on the newly extracted second representation; and (c) Selection of a parameter set by means of which, in method step b), a synthetic image was synthesized which has a shorter distance than one that was synthesized by means of the output parameter set, as a new output parameter set.

The method steps a) to c) are repeated until the distance between the synthetic image synthesized by means of the output parameter set and the photograph meets a termination criterion of the iterative algorithm. As soon as this is the case, parametrization of the program logic is finalized according to the current output parameter set. The termination criterion is advantageous in such a way that if the termination criterion is met, no significant reduction in the distance is to be expected when another iteration is performed.

The field of computer-aided optimization includes numerous iterative optimization methods. For the method according to the invention, optimization methods that are applicable to non-differentiable metrics are advantageous. Preferably, the iterative algorithm is designed as an evolutionary algorithm, wherein the number of parameter sets in the method step a) includes a variety of parameter sets. Evolutionary algorithms are known to be particularly suitable for high-dimensional optimization problems. Particularly preferably, the evolutionary algorithm is designed as a genetic algorithm, wherein each parameter set is a genome and wherein a small distance from the photograph determined for a parameter set implies a high level of fitness of a parameter set. Numerous embodiments of evolutionary algorithms are known from the literature that are applicable to the method according to the invention and may include method steps that are not expressly mentioned in the present description and claims.

The method is an efficient approach of adapting the image synthesis of a graphics engine to a given camera model. The invention thereby improves the applicability of graphics engines for testing and training camera-based control systems. The method can be fully automated and thus also saves the time needed for parameterizing a graphics engine.

The digital photograph is preferably taken with a camera model intended for feeding image data, in particular camera raw data, into a control system for controlling a robot, a semi-autonomous vehicle or an autonomous vehicle. The method then parameterizes the program logic for a synthesis of images that resemble the images generated by said camera model. By means of the program logic, synthetic image data can then be generated after the parameterization has been completed and fed into the control system in order to test, validate or train the control system. Synthetic image data refers in particular to synthetic camera raw data that is generated, for example, on the basis of the images synthesized by the program logic by means of an emulation of a camera chip.

The neural network is advantageously a pre-trained neural network. The neural network does not have to be explicitly trained to assess similarity between images. In principle, it is sufficient if the neural network is designed in some way to input an image at the input layer and to process the image in the hidden layers. For example, the neural network can be designed to solve a puzzle, assign depth to objects in a two-dimensional image, or perform semantic segmentation. In a preferred embodiment of the invention, the neural network is designed as a classifier for recognizing at least one type of object.

Individual neurons in neural networks process their data through activation functions that receive weighted output values of neurons from a previous layer as arguments. Accordingly, the first and second representations are preferably designed as a set of activation function values or activation function arguments of neurons from the selection of neurons. In an exemplary embodiment, an extracted representation is converted into a vector representation of activation function values or activation function arguments, and the determination of the distance includes a determination of a vector similarity, in particular a cosine similarity, or a distance between the two vectors. In another exemplary embodiment, to determine the distance, a first histogram is formed, which depicts a frequency of vectors or scalars in the representation of the synthetic image, and a second histogram is formed, which depicts a frequency of vectors or scalars in the representation of the photograph, and the calculation of a distance is done by calculating a similarity of the first histogram and the second histogram.

According to the applicant's research, training of the neural network using contrastive learning methods seems to be advantageous for the performance of the method. Contrastive learning can be understood in particular to mean expanding the set of training images with targeted falsification of training images. By way of example, falsification can be carried out by one or more of the following types of image manipulation of a training image: rotation, cutting out an image section, cropping, color distortion, distortion, noise.

The neural network can be designed as an autoencoder. An autoencoder, can be understood in connection with the method according to the invention, comprises an encoder part and a decoder part. The encoder part is trained to store an abstract encoded representation of an image in a number of hidden layers of the autoencoder, arranged between the encoder part and the decoder part, and the decoder part is trained to reconstruct the image from the encoded representation. The encoded representation of the image can be used in the context of the method according to the invention as a representation of an image, i.e., of the photograph or a synthetic image.

In the conventional art, a perfect reconstruction of the image by the decoder part is usually not sought. For example, the training goal is usually a denoised image, a compressed image, or a dimension-reduced image. For the performance of the method according to the invention, it seems to be advantageous to train the autoencoder with the goal of perfectly reconstructing the image by means of the decoder part.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a camera-based control system;

FIG. 2 shows a test bench in which the control system is integrated as a DUT in order to test the control system in a virtual environment;

FIG. 3 shows a digital photograph of a three-dimensional scene;

FIG. 4 shows a synthetic image replicating the photograph;

FIG. 5 shows the creation of a first representation of the photograph;

FIG. 6 shows the creation of a second representation of the synthetic image; and

FIG. 7 shows a flowchart of a method according to the invention.

### DETAILED DESCRIPTION

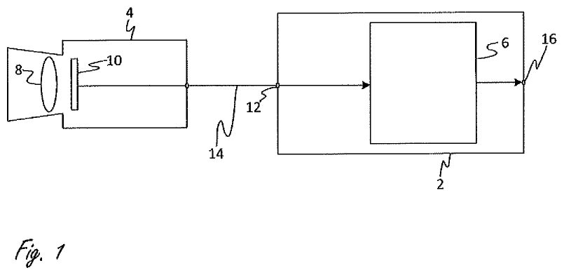

FIG. 1 shows a camera-based control system 2 still under development with a camera model 4 provided for the control system 2. The camera model 4 includes optics 8 for projecting an image of the environment onto a camera chip 10. The camera chip 10 is designed to translate the projected image into camera raw data and to feed the camera raw data as an image data stream via an image data link 14 into an image data input 12 of the control system 2. The control system 2 comprises a processor unit 6, set up for reading the image data stream from the image data input 12 and for processing the image data stream. Object recognition is programmed on the processor unit 6, which is set up to detect objects in the camera raw data, to create an object list of the detected objects and to update the object list in real time, so that the object list represents an up-to-date semantic description of the environment at any point in time. Furthermore, a control routine is programmed on the processor unit, which is set up to read in the object list, to create control commands for actuators on the basis of the object list and to control the actuators via an actuator data output 16 by means of the control commands.

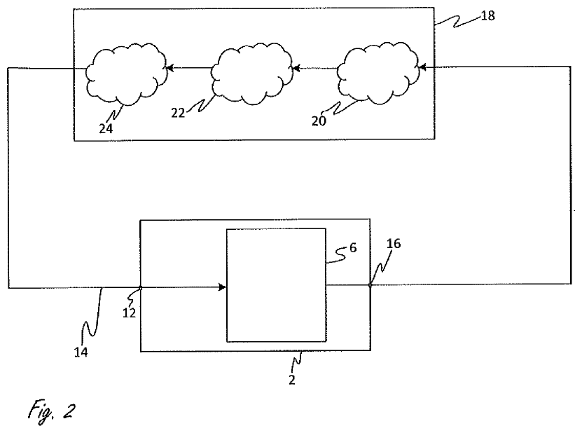

FIG. 2 shows a test bench setup 18 in which the control system 2 is integrated as a DUT. The camera 4 is cut out in the setup. The image data link 14 connects the image data input with the test bench setup 18. The test bench setup 18 comprises a processor unit and is designed to provide the control system 2 with a virtual environment that simulates a real environment of the control system 2.

A dynamic environment model 20 is programmed on the test bench setup 18. The environment model 20 comprises a variety of dynamic and static objects, which in their entirety represent a semantic description of the virtual environment. Each dynamic object is associated with a position and a spatial orientation in the virtual environment, and the environment model 20 is set up to change the position and spatial orientation of each dynamic object in each time step of the simulation in order to simulate a movement of the dynamic objects. The environment model is also set up to simulate interactions between the objects stored in it.

In particular, the environment model 20 comprises a virtual instance of a technical device for the control of which the control system 2 is provided, with a virtual instance of the camera model 4 and virtual instances of the actuators for the control of which the control system 2 is provided. The virtual environment also represents a typical operating environment of the control system 2. By way of example, the control system 2 may be provided for the control of a highly automated automobile, and the test bench setup 18 is provided for testing the operational readiness of the control system in urban traffic. In this case, the environment model 20 includes a virtual test vehicle. A data connection is established between the actuator data output 16 and the test bench setup 18, and the environment model 20 is set up to read in control commands issued at the actuator data output 16 and apply them to virtual instances of the corresponding actuators in the virtual test vehicle. The control system 2 is therefore set up to control the wheel position, longitudinal acceleration and braking force of the virtual test vehicle in the same way as it would in a real vehicle in a physical environment. The virtual test vehicle also includes a virtual camera that is assigned a static position and a static spatial orientation in the reference system of the test vehicle. In accordance with the intended use of the control system 2, the virtual environment replicates an urban environment. The objects in the environment model include automobiles, cyclists, pedestrians, traffic lights, signage, buildings and landscaping. The environment model also includes agents for controlling dynamic objects in order to simulate a realistic movement behavior of the objects.

On the test bench setup 18, a program logic for image synthesis designed as a graphics engine 22 is also programmed. The graphics engine is set up to read out the objects stored in the environment model 20 and the parameters assigned to the objects, in particular position and spatial orientation, to generate a texture assigned to the object for each object and to synthesize a photorealistic two-dimensional perspective image of the virtual environment from the point of view of a virtual camera on the basis of the textures. The graphics engine is designed to synthesize new images in real time within predefined time intervals, in each case taking into account current parameters of the objects and a current position and viewing direction of the virtual camera, in order to simulate a movement of the virtual camera in the virtual environment.

In addition, a camera emulation 24 is programmed on the test bench setup 18 for the emulation of the camera model 4, including an emulation of the optics 8 and the camera chip 10. The graphics engine is set up to synthesize the images from the point of view of the virtual instance of the camera model 4. The camera emulation 24 is set up to read in the images synthesized by the graphics engine 22, to process them by means of the emulation of the optics 8, to generate an image data stream from camera raw data by means of the emulation of the camera chip, which simulates camera raw data of the camera model 4 in the virtual environment, and to feed the data stream from camera raw data into the image data input 12 via the image data link 14. The camera emulation 24 may be logically separate from or integrated into the graphics engine 22. The camera emulation 24 can also be programmed on dedicated and separate hardware.

Thus, the control system 2 is in a closed control loop with the test bench setup 18 and interacts with the virtual environment of the environment model 20 as with the physical environment. Since in the virtual environment it is easy and safe to confront the control system 2 with critical situations that rarely occur in reality, it is desirable to transfer as much of the development of the control system 2 as possible to the virtual environment. This proportion can be all the greater the more realistic the simulation of the virtual environment is, wherein the similarity between the images synthesized by the graphics engine 22 and the images produced by the camera model 4 is of particular importance. The graphics engine includes a variety of adjustable parameters that affect the appearance of the synthesized images. The goal is therefore to determine a set of parameters that creates an optimal similarity.

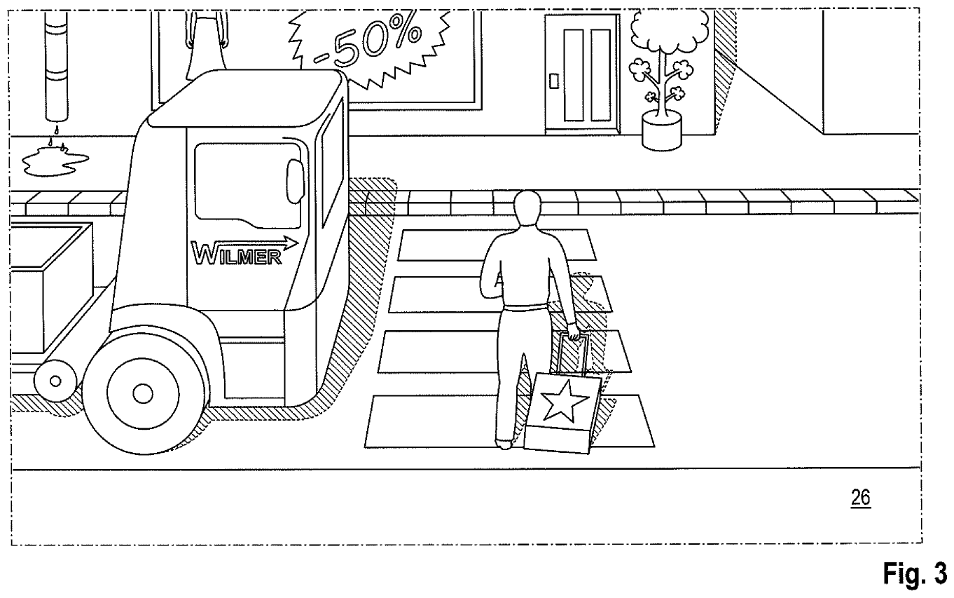

For this purpose, a photograph 26 of a three-dimensional physical scene is first taken using the camera model 4, which advantageously represents a typical operating environment of the control system 2. FIG. 3 exemplifies a photograph 26 of a random street scene taken using the camera model 4. The scene depicted in the photograph 26 is then recreated as a digital three-dimensional model, i.e., a semantic description is made in the form of an environment model 20 readable and processable by the graphics engine 22, which recreates the scene depicted in the photograph 26. (The graphics engine 22 and the environment model 20 do not have to be programmed on the test bench setup 18 to carry out the method steps described below, but can run, for example, on a commercially available PC.) For example, a pedestrian object is stored in the environment model to represent the pedestrian depicted in the photograph 26, which causes the graphics engine 22 to generate a texture representing a pedestrian. Furthermore, the pedestrian object is parameterized in order to adapt it to the pedestrian depicted in the photograph 26 in the best possible way within the scope of the possibilities of the environment model 20 and the graphics engine 22. The parameterization includes in particular the position and spatial orientation of the pedestrian in a three-dimensional global coordinate system of the environment model 20. Other possible examples include physique, posture, clothing, hair color, and hairstyle. The same is done with other objects depicted in the photograph 26. When reconstructing the scene, it is advantageous to strive for as many elements as possible depicted in the photograph 26 to be represented as similarly as possible in the environment model 20.

For the parameterization of the graphics engine 22, an initial set of output parameters is first determined, which includes a selection of adjustable parameters of the graphics engine 22 to be optimized, each of which affects the appearance of the images synthesized by the graphics engine 22, and which assigns a more or less arbitrary value to each parameter. The values stored in the initial output parameter set can, for example, correspond to a standard parameterization of the graphics engine 22, an output parameterization recognized as advantageous for the further execution of the method, or a random value selection.

Examples of possible parameters contained in the initial output parameter set are contrast, color saturation, arrangements of light sources, brightness of light sources, color components of light sources, visibility, image noise as well as optical distortions and lens errors of the optics 8. In principle, the initial output parameter set can also include adjustable parameters of the camera emulation 24. Regardless of whether the camera emulation 24 is logically separated from or integrated into the graphics engine 22, the camera emulation may be understood in the context of the method according to the invention as part of the program logic for image synthesis, since it is involved in the synthesis of the synthetic camera image fed into the control system 2.

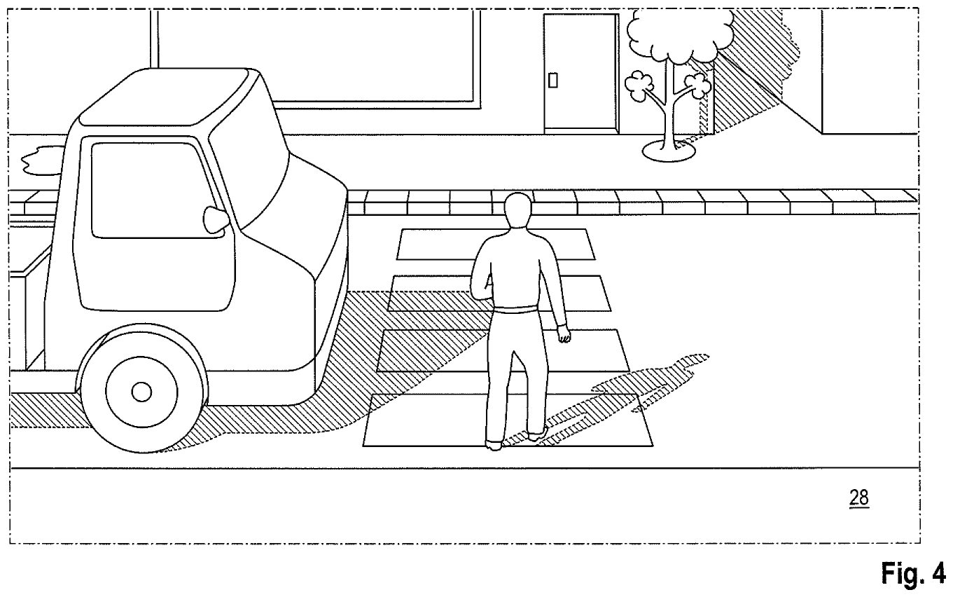

The graphics engine 22 is parameterized by means of the initial output parameter set via a logical programming interface for parameterization of the graphics engine 22, and the position and viewing direction of the virtual camera of the graphics engine 22 are adapted to the camera model 4 when the photograph 26 is taken. Subsequently, a photorealistic image recreating the photograph 26 is synthesized on the basis of the environment model 20. FIG. 4 shows an example of a corresponding synthetic image 28. It can be seen in the figure that the synthetic image 28 is subjectively similar to the photograph 26 overall but differs from the photograph in detail. The reason is that the elements depicted in the photograph 26 are replaced in the synthetic image 28 by generic textures from an object database of the environment model 20. For example, the truck, the pedestrian, and the door in the synthetic image 28 are of a different appearance than their counterparts in the photograph 26. The potted plant in the photograph 26 is represented by a small-scale texture of a tree. Other elements, such as the gutter, the wheeled suitcase, the mannequin and the shop window stickers, are missing in the synthetic image 28 because the object database does not contain any suitable objects or textures.

Such discrepancies between photograph 26 and synthetic image 28 can be reduced by increased effort. One way to do this is to stage the three-dimensional scene depicted in the photograph 26 instead of using a street scene. In this way, the control over the elements contained in the photograph 26 is better. Furthermore, the possibilities for parameterizing the objects in the environment model 20 can be expanded or textures photographed in the scene can be used when generating textures. However, it is practically impossible to eliminate the discrepancies. Therefore, classical methods for calculating image similarity, which are based on a pixel-by-pixel comparison or a comparison of quantizable image characteristics, are hardly suitable as a metric for measuring the similarity between the synthetic image 26 and the photograph 28 by themselves. The absence of individual elements and the divergent shapes of the elements depicted in the synthetic image 28 lead to strong color deviations in individual areas of the image, so that such a metric would never rate the photograph 26 and the synthetic image 28 as similar under certain circumstances, regardless of the parameterization. Conversely, such a metric would also be unsuitable for detecting certain actually existing strong deviations. An example of this is the position of light sources in the environment model 20. For example, the shadows in the synthetic image 28 are different from those in the photograph 26. Thus, the light sources in the synthetic image 28 are arranged differently than those in the photographed scene. A pixel-by-pixel comparative metric would not correctly account for this deviation because different shadows do not affect the color values and, depending on the gradient of the shadows, may not affect the average brightness of the image.

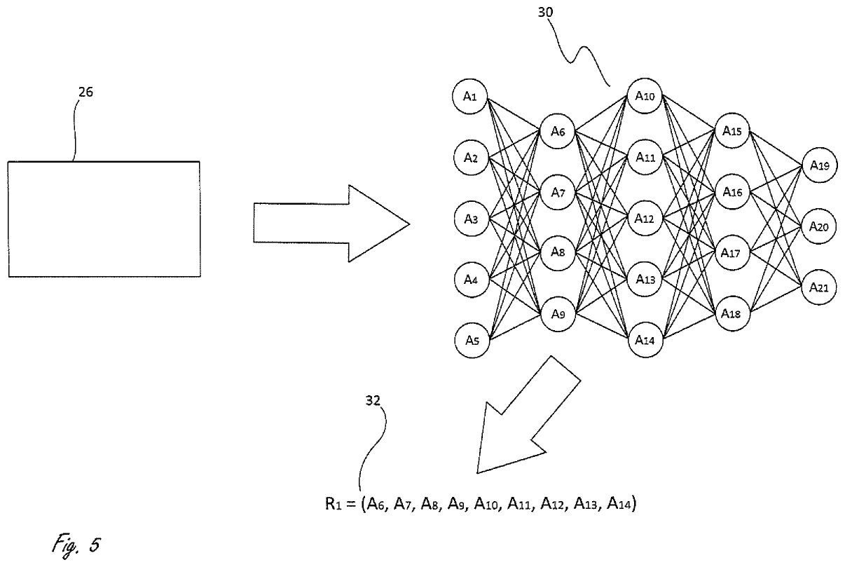

Therefore, in order to assess the similarity of the two images, the photograph 26 is first processed by a neural network 30, as shown in FIG. 5. The neural network 30 is designed and pre-trained to process an image. By way of example, the neural network 30 is designed as a classifier and trained to recognize an object type in an image, wherein, according to the current state of knowledge of the applicant, it is at best of little importance which object type the neural network 30 is trained to recognize. However, it may be advantageous if the neural network 30 through its training is accustomed to images of environments such as those shown in the photograph 26.

Each neuron of the neural network 30 processes the information supplied to it using an activation function and passes on the result of the processing as an activation function value A₁, . . . , A₂₁ to neurons of the respective subsequent layer. After the neural network 30 has processed the photograph 26, an abstract first representation 32 of the photograph 26 is extracted from two hidden layers of the neural network 30 by reading the activation values A₆, . . . , A₁₄ from all neurons of the second and third layers of the neural network 30 and storing them in a vector R₁.

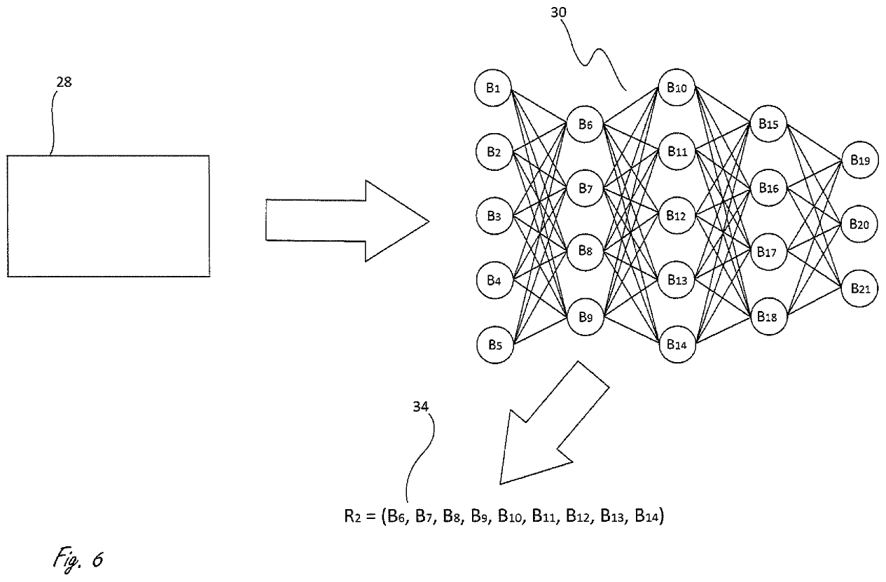

In an analogous manner, represented in FIG. 6, an abstract second representation 34 of the synthetic image 28 is created. The synthetic image 28 is processed by the same neural network 30 from which the first representation 32 has already been extracted. After processing the synthetic image 28, new activation function values B₁, . . . , B₂₁ are stored in the neurons. To extract the second representation 34, the activation function values B₆, . . . , B₁₄ are read from the same neurons from which the first representation 32 is read and stored in a vector R₂.

Using a suitable metric that takes into account the first representation 32 and the second representation 34, the distance between the synthetic image 28 and the photograph 26 is calculated, wherein a small distance implies high similarity of both images. A distance D can be defined by way of example by the formula

D=1−|cos(R₁,R₂)|

Of course, there are also other methods suitable for performing the method to numerically express a similarity of the read activation function values in the first representation 32 and the second representation 34. In another embodiment, frequencies of rounded activation function values from the first representation 32 and second representation 34 are each plotted in a histogram and the similarity of both histograms is determined numerically, for example, by a mean squared deviation or a correlation. Instead of the activation function values, activation function arguments stored in the neurons can alternatively be used. These are weighted activation function values from the previous layer of the neural network 30 in each case. It is also not mandatory that the distance D contains exclusively the first representation 32 and the second representation 34 as arguments. In addition to the first representation 32 and the second representation 34, the distance D may also take into account results from at least one other comparison of the photograph 26 and the synthetic image 28, for example, a mean square deviation of brightness values or color values.

Only for the comprehensible presentation of the invention idea, the neural network 30 is shown in the figures as a very simple network. The neural network 30 can comprise far more layers with far more neurons per layer than shown in the figures. Accordingly, the first representation 32 and the second representation 34 may comprise far more elements extracted from a plurality of layers of the neural network 30. Advantageously, at least one of them is a hidden layer. The input layer still contains the unfiltered information of the entire image, whereas the output layer normally hardly contains any meaningful information within the scope of the method.

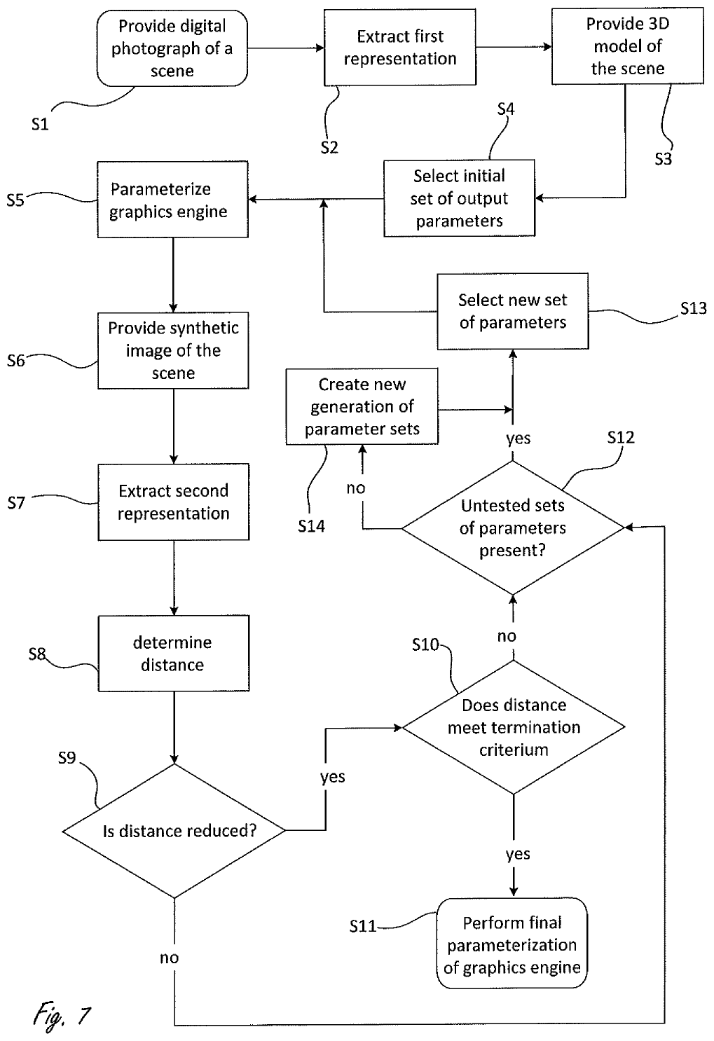

By means of an automated iterative algorithm, the distance D is minimized. FIG. 7 shows the general steps of the iterative algorithm in the form of a flowchart. Preferably, the iterative algorithm is designed as a genetic algorithm in which the initial output parameter set to be optimized is a genome, a variety of new parameter sets are generated in each iteration, and the distance D defines the fitness of a parameter set.

Steps S1 to S8 correspond to the previously described method steps, up to the determination of the distance D. Step S9 is a check to see if the distance is reduced as compared to the previous iteration. In the first iteration, when a distance has been calculated only once, the answer is always no. In the subsequent step S12, it is checked whether parameter sets from the current generation are still untested, i.e., whether at least one parameter set has not yet passed through steps S5 to S8. In step S12, also, the answer in the first iteration is always no, so that in step S14 a second generation of parameter sets is generated by varying the initial output parameter set.

Depending on the design of the iterative method, the second and each subsequent generation may also comprise only one set of parameters. In a genetic process, the second generation comprises a variety of parameter sets, each of which is formed by varying the initial output parameter set. In step S13, a parameter set from the second generation is selected and in step S5, the graphics engine 22 is parameterized with the parameter set selected in step S13.

The newly selected parameter set runs through steps S6 to S9 again. On the basis of the new parameter set, a new synthetic image 28 is synthesized, as described in the description of FIG. 6, the second representation 34, i.e., the vector R₂, is recalculated and the distance D between the new synthetic image 28 and the photograph 26 is calculated. If the distance is less than the distance calculated for a predecessor output parameter set from the previous generation, the parameter set is considered for parameterization of the graphics engine 22. In step S10, it is then checked whether a termination criterion is met. A termination criterion should advantageously imply that no significant reduction in distance D is to be expected from further iteration. In particular, the termination criterion can be a fall below a tolerance value of the distance, or a fall below a tolerance value of a difference between the best distance from the previous generation and the currently calculated distance. If the termination criterion is met, the parameterization of the graphics engine 22 is finalized in step S11 with the parameter set for which the smallest distance was calculated in step S8.

If the termination criterion is not met, step S12 is performed again. If there are still unchecked parameter sets in the current generation, they are checked one after the other. Otherwise, another generation of parameter sets is created in step S14. In a genetic algorithm, step S14 comprises a selection of the fittest parameter sets from the current generation for reproduction, i.e., one or more parameter sets are selected, each of which belonging to a group of the fittest parameter sets for which particularly short distances have been calculated in step S8 and from which a variety of new parameter sets are generated by variation and/or recombination.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for parameterizing a program logic for image synthesis, which is designed to synthesize a photorealistic perspective representation of a 3D model, the appearance of which depends on a variety of adjustable parameters, the method comprising:
providing a digital photograph of a three-dimensional scene;
processing the digital photograph by a neural network;
extracting a first representation of the photograph from a selection of neurons from the neural network;
providing a digital three-dimensional model of the scene;
parameterizing the program logic according to an initial set of output parameters;
synthesizing a synthetic image recreating the digital photograph via the parameterized program logic based on the three-dimensional model;
processing the synthetic image by the neural network;
extracting a second representation of the synthetic image from the same selection of neurons from which the first representation is extracted;
calculating a distance between the synthetic image and the photograph using a metric taking into account the first representation and the second representation;
producing an improved set of output parameters by an evolutionary algorithm with the following method steps a) to c):
(a) producing a plurality of parameter sets by varying the output parameter set;
(b) for each set of parameters from the plurality of parameter sets:
parameterizing the program logic according to the parameter set;
resynthesizing the synthetic image via the program logic parameterized according to the parameter set;
processing the new synthetic image by the neural network;
re-extracting the second representation of the new synthetic image from the same selection of neurons from which the first representation is extracted; and
calculating the distance between the new synthetic image and the digital photograph;
c) selecting a parameter set via which a synthetic image was synthesized in method step b) with a shorter distance than one synthesized via the output parameter set, as a new output parameter set;
repeating the method steps (a) to (c) until the distance between the synthetic image synthesized via the output parameter set and the photograph meets a termination criterion of the evolutionary algorithm; and
parameterizing the program logic according to the output parameter set.

2. The method according to claim 1, wherein the selection of neurons comprises, at least proportionately, neurons from a hidden layer of the neural network.

3. The method according to claim 1, further comprising: capturing the digital photograph with a camera model provided for feeding image data or camera raw data into a control system for controlling a robot, a semi-autonomous vehicle or an autonomous vehicle.

4. The method according to claim 3, further comprising:
generating, after completion of the parameterization of the program logic, synthetic image data or camera raw data via the program logic; and
feeding the synthetic image data into the control system for testing or validation of the control system or training a neural network of the control system using the synthetic image data.

5. The method according to claim 1, wherein the first representation and the second representation are designed as a set of activation function values or activation function arguments of neurons from the selection of neurons.

6. The method according to claim 1, wherein the neural network is designed as a classifier for the recognition of at least one object type.

7. The method according to claim 1, further comprising: training the neural network by contrastive learning.

8. The method according to claim 1, wherein the neural network is designed as an autoencoder and the first representation is an encoded representation of the digital photograph extracted from at least one layer of the autoencoder arranged between an encoder part and a decoder part.

9. The method according to claim 8, further comprising: training the autoencoder with the training goal of a perfect reconstruction by the decoder part of an image encoded by the encoder part.

10. The method according to claim 1, further comprising: calculating the distance by calculating a similarity between a first histogram of a frequency of vectors or scalars in the second representation and a second histogram of a frequency of vectors or scalars in the first representation.

11. The method according to claim 1, further comprising: calculating the distance by calculating at least one vector similarity or a distance between the second representation and the first representation.

12. The method according to claim 1, wherein the selection of neurons is designed as a selection of layers of the neural network and includes all neurons belonging to the respective layer from the selection of layers.

13. A test bench setup to test a control system set up to feed image data into the control system via a camera model, on which a program logic is programmed for image synthesis that is designed to synthesize a photorealistic perspective representation of a 3D model, the appearance of which depends on a variety of adjustable parameters, and on which a camera emulation is programmed to emulate the camera model, which is set up to read images synthesized by the program logic and to generate an image data stream and feed it into an image data input of the control system, the test bench setup comprising:
a computer program product:
to create a parameter set for the parameterization of the program logic, which is set up to process a digital photograph of a three-dimensional scene taken with the camera model by a neural network;
to extract a first representation of the photograph from a selection of neurons from the neural network;
a synthetic image recreating the photograph, which was synthesized by the program logic parameterized according to an initial output parameter set on the basis of a three-dimensional model, to be processed by the neural network;
to extract a second representation of the synthetic image from the same selection of neurons from which the first representation is extracted;
to calculate a distance between the synthetic image and the digital photograph using a metric that takes into account the first representation and the second representation;
to generate an improved output parameter set through an evolutionary algorithm, comprising the steps a) to c):
(a) creating a plurality of parameter sets by varying the output parameter set;
(b) for each set of parameters from the plurality of parameter sets:
parameterizing the program logic according to the parameter set;
resynthesizing the synthetic image by the program logic parameterized according to the parameter set;
processing the new synthetic image by the neural network;
re-extracting the second representation of the new synthetic image from the same selection of neurons from which the first representation is extracted; and
calculating the distance between the new synthetic image and the photograph;
c) selecting a set of parameters via which in step (b) a synthetic image has been synthesized with a shorter distance than one synthesized by means of the output parameter set, as a new output parameter set; and
repeating the method steps a) to c) until the distance between the image synthesized by the output parameter set and the photograph meets a termination criterion of the evolutionary algorithm.
